(19) United States
(12) Patent Application Publication
(10) Pub. No.: US 2007/0094080 A1
(43) Pub. Date: Apr. 26, 2007

(54) Smart shopping method and system

(75) Inventor: Lawrence F. Wiken, Wayzata, MN (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: CoalitionWorks, LLC, Wayzata, MN (US)

(21) Appl. No.: 11/583,453

(22) Filed: Oct. 19, 2006

Related U.S. Application Data
(60) Provisional application No. 60/728,844, filed on Oct. 21, 2005.

(51) Int. Cl. G06Q 30/00

(52) U.S. Cl. 705/14

(57) ABSTRACT

A smart shopping system, method and program are provided. The cost-effective system, method and program provide for uploading participating partners' digital savings and rewards offers to a program administration website; approving offer content by a system administrator and escrow payment of all savings and rewards offer liabilities by participating partners; activating approved savings and rewards offers through a program interactive website; providing members' selection of relevant savings and rewards offers, including auto offers, and selecting savings and rewards offers to be stored on a secure offer management file; storing member selections and purchase history in a secure offer management database; providing one unique identifier for redeeming savings and rewards offers from a plurality of partners at or through a point of sale system; reporting and tracking members' savings and rewards offer selections and redemptions; and providing banking and accounting functions for reconciliation and reimbursement to participating partners.

### CROSS REFERENCE TO RELATED APPLICATION

This application is based on and claims the benefit of U.S. Provisional Application No. 60/728,844, filed Oct. 21, 2005, the entirety of which is hereby incorporated by reference.

### BACKGROUND OF THE INVENTION

1. Field of the Invention

The present invention relates to a cost-effective system, method and program for an interactive, secure internet portal system for content delivery and digital communications and advertising. More particularly, the present invention relates to a system, method and program for a real-time, paperless environment for cost efficient delivery of flexible and dynamic content that includes savings and rewards offers and advertorial content, to members from participating brand and channel partners as well as other on-line and off-line retail partners.

2. Discussion of the Related Art

Discounting of goods and services, including electronic distribution of discounts, is known. Current forms of consumer discounts require consumers to gather physical coupons and present them at a point of sale (POS) terminal in order to receive discounts. Coupons can be distributed in paper form via newspapers (free-standing inserts), magazine inserts, product packaging, direct mail and the like. Coupons can also be transmitted in electronic form, for example by transmitting electronic coupons to Internet sites and, in a limited capacity, to wireless devices. These physical and electronic coupons include some sort of product and discount identification information, such as a barcode, that is readable by POS terminals. Problems with these types of coupons include high costs to sponsors for distribution and administration for redeemed coupons (auditing, clearinghouse functions, and manufacturers' agent settlements), complex and/or time consuming actions required by consumers to gather and redeem coupons, fraud or tampering with product and/or discount information on coupons, lack of control over number of discounts per consumer, insufficient information for target marketing of consumer groups, and the like.

In response to some of these problems, some sponsors have developed consumer discount programs in which individual consumers utilize a personal identification number (PIN) or other such unique identifier in order to obtain discounts at a POS terminal. In these systems, an account is established for each consumer with a unique identifier for each account. Consumers can access their accounts by entering their unique identifier. They are then presented with items for which discounts are being offered. They can select discounted items to be associated with their unique identifier. Upon purchase of the selected discounted items at an associated store, consumers enter their unique identifier or present a rewards card associated with their unique identifier at the POS terminal and data about their selected discounted items are received by the retailer over a network. The discount selections and purchases are automatically reconciled to record a credit in consumers' accounts. Problems with these types of consumer discount programs include consumers are still required to engage in complex and/or time consuming actions to select and redeem coupons; sponsors still suffer high costs for distribution and administration for redeemed coupons because discounts are offered by individual sponsors; and consumers are required to remember multiple unique identifiers and/or carry multiple reward cards. Based on the foregoing, there exists a need for a cost-effective system, method and program encompassing a network of participating partners driven by an identity-based program that is independent of any partner, vertical or horizontal, and any other programs or offers, thereby eliminating the need for multiple identification cards, keys, etc. There exists yet another need for a cost-effective system, method and program that provide rules and inference-based capability for delivering individualized savings and rewards offers and advertorial content to participating consumers based on their browsing, selection, and purchasing behavior.

### SUMMARY OF THE INVENTION

It is an object of the present invention to provide a cost-effective system, method and program for a network of participating brand partners driven by an identity-based program that is independent of any partner, vertical or horizontal, and any other programs or offers, thereby eliminating the need for multiple identification cards, keys, and the like. It is also the object of the present invention to disintermediate existing process flows by eliminating the need for clearinghouse functions and agent settlements thereby significantly reducing costs to participating partners. It is a further object of the present invention to provide a cost-effective system, method and program that provide rules and inference-based capability for delivering individualized savings and rewards offers and advertorial content to participating consumers based on their browsing, selection, and purchasing behavior. It is still a further object of the present invention to provide reporting and tracking of participating consumers' selections and/or redemptions. It is yet a further object of the present invention to provide banking and accounting functions for reconciliation and/or reimbursement to participating brand and channel partners.

These and other objects and advantages of the present invention are accomplished by a cost-effective system, method and program for an interactive, secure internet portal system for content delivery and digital communications and advertising in accordance with the present invention. In one embodiment there is a method for a smart shopping program embodied on a computer readable medium, including steps for uploading participating partners' digital savings and rewards offers to a program administration website; approving offer content by a system administrator and escrow payment of all savings and rewards offer liabilities by participating partners; activating approved savings and rewards offers through a program interactive website; providing members' selection of relevant savings and rewards offers through a computing means and selecting savings and rewards offers to be stored on a secure offer management file; storing member selections and purchase history in a secure offer management database; redeeming digital savings and rewards offers at a point of sale means; reporting and tracking of members' savings and rewards offer selections and redemptions; and providing banking and accounting functions for reconciliation and reimbursement to participating partners.

In another embodiment, there is a smart shopping computer program stored on a computer readable medium and including a code segment for uploading participating partners' digital savings and rewards offers to a program administration website; a code segment for approving offer content by a system administrator and escrow payment of all savings and rewards offer liabilities by participating partners; a code segment for activating approved savings and rewards offers through a program interactive website; a code segment for providing members' selection of relevant savings and rewards offers through a computing means and selecting savings and rewards offers to be stored on a secure offer management file; a code segment for storing member selections and purchase history in a secure offer management database; a code segment for redeeming digital savings and rewards offers at a point of sale means; a code segment for reporting and tracking of members' savings and rewards offer selections and redemptions; and a code segment for providing banking and accounting functions for reconciliation and reimbursement to participating partners.

In yet another embodiment, there is a computerized system for a smart shopping software application including a processor; and a storage device including a code segment for uploading participating partners' digital savings and rewards offers to a program administration website; a code segment for approving offer content by a system administrator and escrow payment of all savings and rewards offer liabilities by participating partners; a code segment for activating approved savings and rewards offers through a program interactive website; a code segment for providing members' selection of relevant savings and rewards offers through a computing means and selecting savings and rewards offers to be stored on a secure offer management file; a code segment for storing member selections and purchase history in a secure offer management database; a code segment for redeeming digital savings and rewards offers at a point of sale means; a code segment for reporting and tracking of members' savings and rewards offer selections and redemptions; and a code segment for providing banking and accounting functions for reconciliation and reimbursement to participating partners.

The invention will be further described with reference to the following detailed description taken in conjunction with the drawings.

### DESCRIPTION OF DRAWINGS

FIG. 1 is a flowchart illustrating one embodiment of a method for delivering individualized savings and rewards offers and advertorial content to participating consumers in accordance with the present invention.

FIG. 2 is a flowchart of one embodiment for enrolling or establishing constituents, including manufacturing partners, channel partners and members, in accordance with the present invention;

FIG. 3 is a flowchart of one embodiment for program set up and administration in accordance with the present invention;

FIG. 4 is a flowchart illustrating one embodiment for loading and activating process steps in accordance with the present invention;

FIG. 5 is a flowchart illustrating one embodiment for savings and rewards redemption at a POS;

FIG. 6 is a flowchart illustrating one embodiment for scoring points and redeeming savings and rewards in accordance with the present invention; and

FIG. 7 is a block diagram illustrating exemplary components of the system of the present invention as it is incorporated into a network system.

### DETAILED DESCRIPTION

Bringing a product to market can involve a complicated manufacturing and distribution process. By the time a product is available to a consumer it has typically been processed by at least one manufacturer and moved through various channels of distribution. Prices of consumer goods include costs for all of the steps necessary to deliver the product to the consumer. Accordingly, savings on consumer products can be derived from manufacturers and distributors along the supply chain. The present invention includes a cost-effective, smart shopping method, system and program for providing savings and rewards to consumers via a partnership of brand partners, distribution channel partners, and other on-line and off-line retail partners. Brand partners include, but are not limited to, manufacturers of consumer packaged goods, soft goods, hard goods, electronics, and the like.

The participating distribution channel partners include, but are not limited to, retailers such as grocery stores, drug stores, mass merchandisers, convenience stores, telecommunications companies, petroleum companies, etc. that collectively represent the majority of consumer average annual spending. The savings and rewards offers presented to consumers include, but are not limited to, cents off and 2-for-1 offers, cash rebates, sweepstakes/contests, points, miles, free product, bundled brand offers, stored value, and the like.

The term “database” as used herein refers to any database structures known in the art, including but not limited to object oriented database structures as disclosed in U.S. Pat. No. 6,374,252 to Althoff et al. and knowledge oriented data structures as disclosed in U.S. Patent Publ. No. 2003/0069871 A1, the entireties of which are hereby incorporated by reference, and other known database and/or data structure programs and systems.

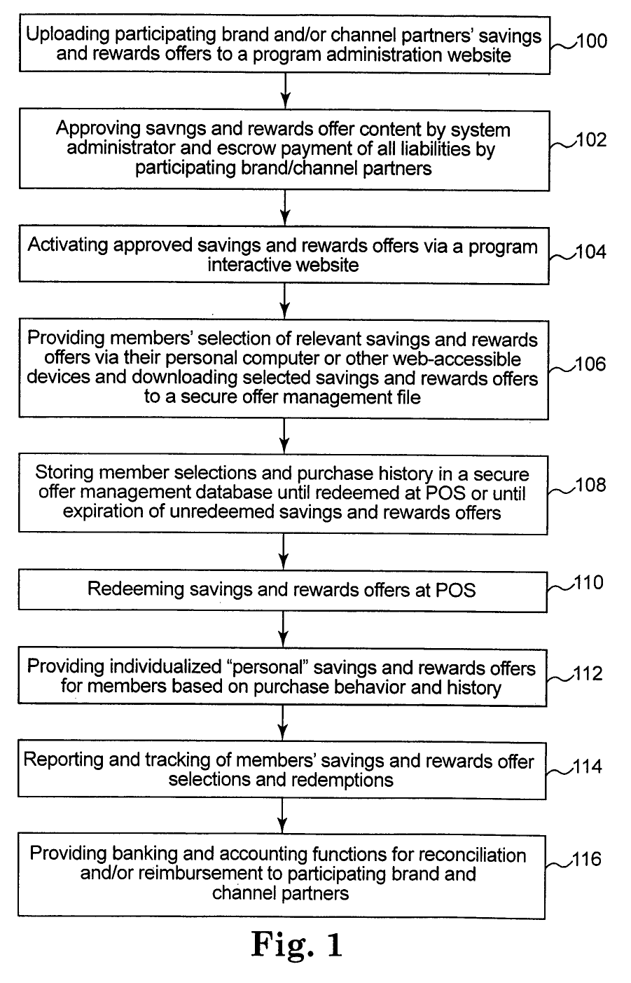

Referring now to FIG. 1, there is shown one embodiment of a smart shopping method in accordance with the present invention. This method includes the steps of: uploading participating brand and/or channel partners' digital savings and rewards offers to a program administration website 100; approving offer content by system administrator and escrow payment of all offer and transaction fees by participating brand/channel partners 102; activating approved savings and rewards offers via a program interactive website 104; providing members' selection of relevant savings and rewards offers via their personal computer or other web-accessible devices using keyword searches, browsing, virtual store navigation and downloading selected savings and rewards offers to a secure offer management file 106; storing member selections and purchase history in a secure offer management database until redeemed at POS or until expiration of unredeemed savings and rewards offers 108; redeeming digital offers at POS 110; providing individualized “personal” savings and rewards offers for members based on purchase behavior and history 112; reporting and tracking of members' savings and rewards offer selections and redemptions 114; and providing banking and accounting functions for reconciliation and/or reimbursement to participating brand and channel partners 116.

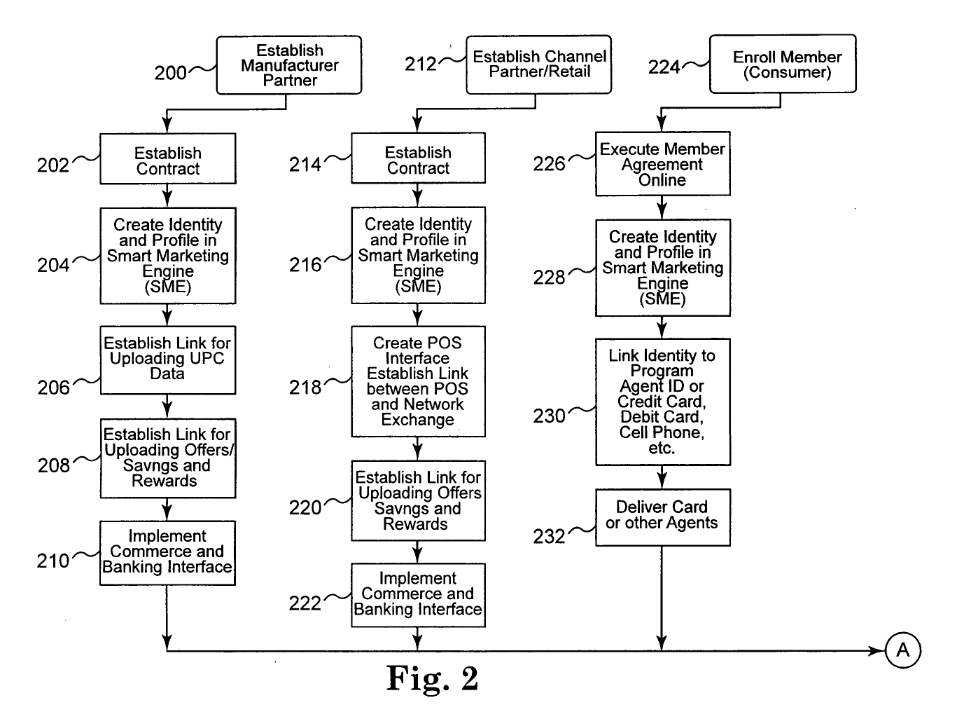

Referring now to FIG. 2, there is shown one method for enrolling or establishing constituents in the system. The constituents include, but are not limited to, manufacturer partners, channel partners, retail partners and consumer members. While the embodiment shown in FIG. 2 depicts simultaneous enrollment or establishment of all of these constituents, those skilled in the art can appreciate that constituents can also be enrolled or established separately in any order.

One method for establishing a manufacturing partner 200 in accordance with the present invention includes the steps of establishing a contract 202; creating an identity and profile in a smart marketing engine (SME) 204; establishing a link for uploading UPC data 206; establishing a link for uploading savings and rewards offers 208; and implementing commerce and banking interfaces 210. During the step of establishing a contract 202 all participating manufacturer partners enter into a binding contractual agreement with the system administrator in which the terms and conditions of the business relationship and participation in the smart shopping program are defined. During the step of creating an identity and profile 204, all participating manufacturing partners provide sufficient identification, to be maintained within an SME database in order to allow for proper management of each partner's account. One skilled in the art can appreciate that such information includes, but is not limited to, contact name and telephone number and bank routing data and account type data for the purpose of electronic funds transfer.

During the step for establishing a link for uploading UPC data 206, all UPCs can be maintained within the SME database. Alternately, UPCs can be accessed in various data locations via a network that communicates with the SME database. In order to establish a link for uploading offers 208, all savings and rewards offers are assigned an offer code that is maintained within the SME database. In one embodiment, approval and assignment of offer codes is conducted via the Internet. In another embodiment, approval and assignment of offer codes can be conducted manually or by any other method or system known in the art. All savings and rewards performance fees must be paid by each partner via electronic funds transfer prior to the savings and rewards being offered via the Internet.

When implementing a commerce and banking interface 210, a communications link between the system administrator, each participating partner and each participating partners' bank is established for the purpose of e-mail communications, mobile messaging, electronic funds transfer, and the like.

Referring again to FIG. 2, there is shown a method for enrolling or establishing a channel partner 212 in accordance with the present invention, including the steps of establishing a contract 214; creating an identity and profile in SME 216; integrating proprietary software into a POS interface and establishing a link between the POS and SME through a proprietary network exchange 218; establishing a link for uploading savings and rewards offers 220; and implementing a commerce and banking interface 222. During the step of establishing a contract 214, all participating channel and retail partners enter into a binding contractual agreement with the system administrator detailing the terms and conditions of the business relationship and participation in the smart shopping program.

During the step of creating an identity and profile 216, all participating channel and retail partners provide sufficient identification, to be maintained within the SME database in order to allow for proper management of the partners' accounts. Those skilled in the art can appreciate that such information includes, but is not limited to, contact name and telephone number and bank routing data and account type data for the of purpose electronic funds transfer. During the step of integrating SME software into a POS interface and establishing a link between the POS and SME through the proprietary network exchange 218, a communications link is established between the SME database and the channel/retail partners' POS for the purpose of identifying consumer members via their membership ID. The link is also used to identify all the savings and rewards offers selected, or e-clipped by the consumer member. A separate communications link between the proprietary network exchange and the partners' POS can also be established in order to validate and identify each transaction according to the UPC used and the savings and rewards offer code.

When establishing a link for uploading savings and rewards for store offers 220, all savings and rewards offers are assigned an offer code that is maintained within the SME database. In one embodiment, approval and assignment of offer codes is conducted via the Internet. In another embodiment, approval and assignment of offer codes can be conducted manually or by any other method or system known in the art. All savings and rewards performance fees must be paid by each partner via electronic funds transfer prior to the savings and rewards being offered via the Internet. In one embodiment, this step 220 is conducted independently from step 208 for establishing a link for uploading savings and rewards offers when establishing a manufacturer partner.

Still referring to FIG. 2, in order to implement a commerce and banking interface, a communications link between the systems administrator, each participating channel/retail partner and each participating channel/retail partners' bank will be established for the purpose of e-mail communications, SMS and mobile messaging, electronic funds transfer, and the like. In one embodiment, this step 222 is conducted independently from step 210 for implementing a commerce and banking interface when establishing a manufacturer partner.

Referring again to FIG. 2, there is shown a method for enrolling or establishing a consumer member in the smart shopping program 224 in accordance with the present invention. Method 224 includes the steps of executing a member agreement 226; creating an identity and profile in SME 228; linking the identity to some sort of unique identifier 230; and optionally delivering a card or some other identifier to each consumer member 232.

During the step for executing a consumer member agreement 226, consumers are required to enroll in the smart shopping program. In one embodiment, membership enrollment can be conducted on-line. In another embodiment, membership enrollment can be conducted manually by mail, in person, or any other registration method known in the art. The consumer member must read and accept the program terms and conditions (including any marketing agreements) as well as review the privacy policy prior to enrolling in the program. When creating a consumer member identity and profile 228, all consumer members are required to provide sufficient identification, to be maintained within the secured SME database in order to allow for proper establishment and management of their personal smart shopping account. Such information includes, but is not limited to, name, address, phone numbers, user name, password, membership ID, etc. In one embodiment, establishment and management of personal smart shopping accounts is conducted online via the Internet. In another embodiment, establishment and management of personal smart shopping accounts can be conducted manually by mail, in person, or any other method known in the art.

During the step for linking identity agents 230, members can choose, on an “opt-in” basis, to register their existing identity agents for use in the smart shopping program. Identity agents include, but are not limited to, credit/debit cards, frequent shopper program card(s), wireless devices, and the like. This allows consumer members to take advantage of multiple partners' on-line offers without the need for a smart shopping membership card. Further, wireless devices may also be registered for the purpose of receiving SMS text alerts or mobile messages with savings and rewards offers.

In order to deliver a unique identifier or some other identification mechanism 232, upon enrollment in the smart shopping program, all consumer members are sent a permanent membership identifier for use at POS terminals. The identifier contains the consumer member's unique identification code that, when scanned or read at POS, triggers all savings and rewards offers selected by the consumer member.

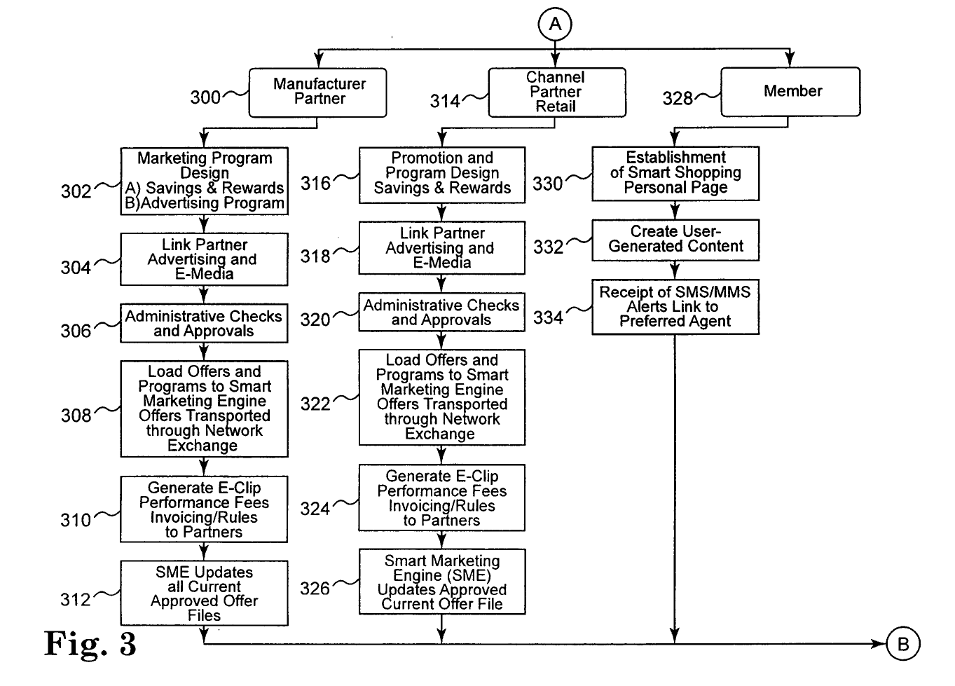

Referring now to FIG. 3, there is shown one embodiment for a program set up and administration in accordance with the present invention. While the embodiment shown in FIG. 3 depicts simultaneous setup and administration of manufacturer partners, channel partners or retailers, and consumer members, those skilled in the art can appreciate that these three constituents can also be setup and the program administered to them separately and/or in any order.

Referring again to FIG. 3, there is shown one embodiment for setting up and administering the smart shopping program for manufacturer partners 300. This embodiment includes the steps of each manufacturer partner providing a marketing program 302; linking all manufacturer partner advertising and electronic media information via the SME database 304; providing review and approval of all savings and rewards offers by the system administrator 306; storing all approved savings and rewards offers in the SME database and transporting them to the proprietary network exchange database 308; generating invoice fees and rules for manufacturer partners based on members' savings and rewards selections 310; and updating approved savings and rewards offers to a live offer database, creating inference links for action by the SME during member shopping list construction and offer selection and updating the SME rules engine with all new and changed rules defined in the approved offers 312.

When conducting the step for each manufacturer partner providing a marketing program 302, all manufacturer partners provide a detailed description of each savings and rewards offer, including savings and rewards and an advertising program associated with the savings and rewards. In one embodiment, an on-line savings and rewards offer checklist available via the Internet will be used by manufacturer partners to ensure they provide a complete, detailed description of each savings and rewards offer. In another embodiment, the savings and rewards offer checklist is a manual list or any such list that prompts the manufacturer partners to provide complete information with regard to the savings and rewards and associated advertising program. The checklist includes information items including, but limited to, type of offer, UPCs impacted, duration of savings and rewards offer, geographic availability, projected response rates, and smart marketing actions (SMA) e-clips to be generated based on member selections and buying behavior.

When performing the step of linking all manufacturer partner advertising and electronic media information via the SME database 304, an intelligent agent capability within the SME database creates SMA offers linked to any manufacturing partner's e-advertising campaigns on their home website or on banner advertising on portals such as Internet search engines. In order to provide review and approval of all savings and rewards offers by the system administrator 306, the system administrator reviews and approves all partner savings and rewards offers. Upon approval, a system-generated savings and rewards offer code, linked to the savings and rewards offer and UPCs is assigned and loaded into the SME database. Upon receipt of all performance fees due by the partners, savings and rewards offers go live on the Internet. In one embodiment, partners are alerted via an offer notification engine. In another embodiment, partners are alerted via e-mail. In still another embodiment, partners are alerted via SMS/MMS alerts. When performing the step for storing all approved savings and rewards offers in the SME database and transporting them to the proprietary network exchange database 308, all savings and rewards offers are stored on the SME database and transmitted to the Proprietary network exchange database.

When performing the step of generating invoice fees and rules for manufacturer partners based on members' savings and rewards selections 310, performance fees are electronically transferred from the manufacturer partners to the system administrator. In one embodiment, the electronic transfer of performance fees is conducted at midnight CST by manufacturing partners on a daily basis. In another embodiment, the electronic transfer of performance fees is conducted as negotiated with the system administrator. The final step includes updating approved savings and rewards offers to a live offer database, creating inference links for action by the SME during member shopping list construction and offer selection and updating the SME rules engine with all new and changed rules defined in the approved offers 312.

Referring again to FIG. 3, there is shown one embodiment for setting up and administering the smart shopping program for channel partners or other retailers 314. This embodiment includes the steps of each channel partner or other retailer providing a marketing program 316; linking all channel partner or other retailer advertising and electronic media information via the SME database 318; providing review and approval of all savings and rewards offers by the system administrator 320; storing all approved savings and rewards offers in the SME database and transporting them to the proprietary network exchange database 322; generating invoice fees and rules for channel partners or other retailers based on members' savings and rewards selections 324; and updating approved savings and rewards offers to a live offer database, creating inference links for action by the SME during member shopping list construction and offer selection and updating the SME rules engine with all new and changed rules defined in the approved offers 326.

When conducting the step for each channel partner or other retailer providing a marketing program 316, all channel partners or other retailers provide a detailed description of each savings and rewards offer, including savings and rewards and an advertising program associated with the savings and rewards. In one embodiment, an on-line savings and rewards offer checklist available via the Internet will be used by channel partners or other retailers to ensure they provide a complete, detailed description of each savings and rewards offer. In another embodiment, the savings and rewards offer checklist is a manual list or any such list that prompts the channel partners or other retailers to provide complete information with regard to the savings and rewards and associated advertising program. The checklist includes information items including, but not limited to, type of offer, UPCs impacted, duration of savings and rewards offer, geographic availability, projected response rates, and smart marketing actions (SMA) e-clips to be generated based on member selections and buying behavior.

When performing the step of linking all channel partner or other retailer advertising and electronic media information via the SME database 304, an intelligent agent capability within the SME database creates SMA offers linked to any channel partner or other retailer's e-advertising campaigns on their home website or on banner advertising on portals such as Internet search engines. In order to provide review and approval of all savings and rewards offers by the system administrator 306, the system administrator reviews and approves all partner savings and rewards offers. Upon approval, a system-generated savings and rewards offer code, linked to the savings and rewards offer and UPCs is assigned and loaded into the SME database. Upon receipt of all performance fees due by the partners, savings and rewards offers go live on the Internet. In one embodiment, partners are alerted via an offer notification engine. In another embodiment, partners are alerted via e-mail. In still another embodiment, partners are alerted via SMS/MMS alerts. When performing the step for storing all approved savings and rewards offers in the SME database and transporting them to the proprietary network exchange database 308, all savings and rewards offers are stored on the SME database and transmitted to the Proprietary network exchange database.

When performing the step of generating invoice fees and rules for channel partners or other retailers based on members' savings and rewards selections 310, performance fees are electronically transferred from the channel partners or other retailers to the system administrator. In one embodiment, the electronic transfer of performance fees is conducted at midnight CST by channel partners or other retailers on a daily basis. In another embodiment, the electronic transfer of performance fees is conducted as negotiated with the system administrator. The final step includes updating approved savings and rewards offers to a live offer database, creating inference links for action by the SME during member shopping list construction and offer selection and updating the SME rules engine with all new and changed rules defined in the approved offers 312.

Referring again to FIG. 3, there is shown one embodiment for setting up and administering the smart shopping program for consumer members 328. This embodiment includes steps for establishing a smart shopping personal page for each consumer member 330; creating user-generated content based on selections made by individual consumer members 332; and providing SMS/MMS alerts to a consumer member's preferred agent 334. The step of the establishing a smart shopping personal page for each consumer member 330 includes establishing a web page that serves as the consumer member's activity and shopping history page as well as the source for SMA individualized savings and rewards offers based on shopping behavior and preferences. The consumer member's personal page is populated based on the information gathered during the step for enrolling or establishing a consumer member in the smart shopping program 224 (shown on FIG. 2). All point earnings and redemption activity is also maintained on the personal page. The consumer member's personal page is automatically updated at the completion of a POS transaction.

When performing the step for creating user-generated content based on selections made by individual consumer members 332, the personal page also serves as a link to a member community for the exchange of information and ideas via user-generated content. Linking is achieved via an automated communication method, including but not limited to Instant Messaging, chat rooms, and blogging. The step for providing SMS/MMS alerts to a consumer member's preferred agent 334, includes agents selected from the group including, but not limited to mobile telephones, wireless devices, PDA's and the like. Consumer members who have registered their mobile telephone numbers will receive savings and point summary SMS alerts. In another embodiment, SMA auto offers, based on latest purchase information, may also be forwarded via SMS mobile messaging to the wireless device. SMA auto offers may contain barcodes, or other identifying offer code information, that can be stored in the wireless device and transmitted or scanned at the POS.

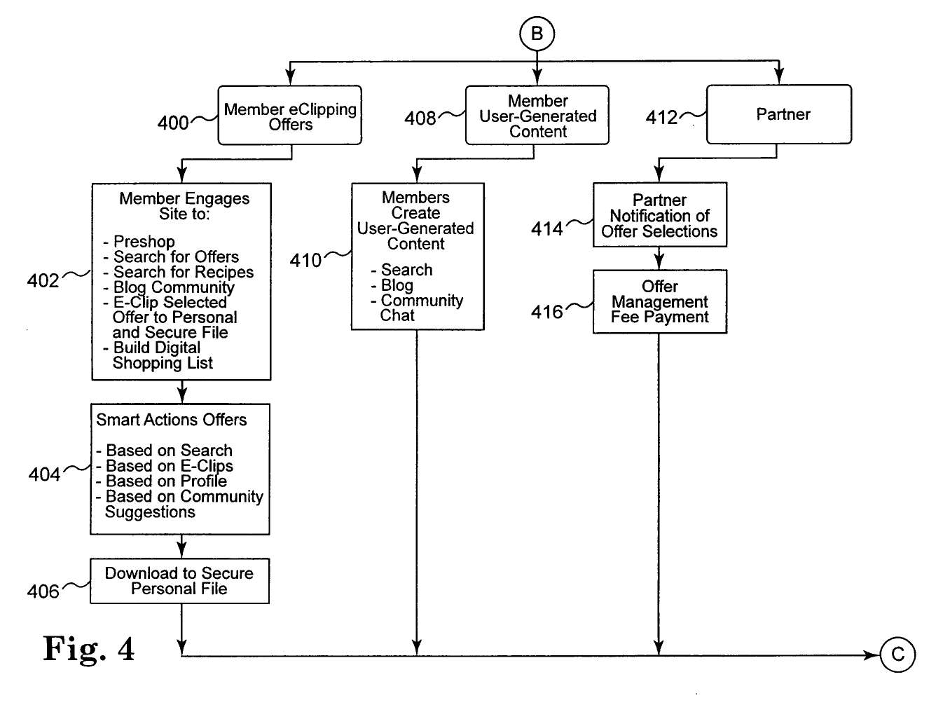

Referring now to FIG. 4, there is shown one embodiment for a method for member consumers to e-clip savings and rewards offers of their choosing. In this embodiment, consumer members e-clip savings and rewards offers 400 by engaging a smart shopping website 402. The SME database validates the consumer member's user name and password and returns a welcome message. All current partner offers are available for searching, viewing and e-clipping. Consumer members can browse and search by various types of information, including but not limited to, category, specific partner, type of offer (cents off, rebate, etc.), or keyword(s). Examples of keywords may be “recipes” or “vegan only”. In one embodiment, search and selection is conducted via “virtual store browsing.” As savings and rewards are selected they are recorded and stored within the SME database as well as on the consumer member's secure offer file, shopping list, or in the member's recipe box.

While consumer members browse, search and/or e-clip savings and rewards offers, individualized savings and rewards offers are offered to the consumer members via smart marketing actions (SMA's) 404. The SMA suggestions can be based on individual consumer members' profile, search and browsing pattern, recipe selection, and actual e-clips. As offers or recipes are e-clipped they automatically populate the consumer member's file and a digital shopping list/recipe box 406. Upon completion of the e-clipping process, the consumer member can either print a paper copy of the shopping list or download it to a cellular telephone, PDA or other wireless device.

Referring still to FIG. 4, in addition to individual consumer member selection, e-clipping and storage, one method in accordance with the present invention provides for the member community sharing information and ideas by creating user-generated content 408. User-generated content can be created via various communication tools including, but not limited to, shopping blogs, instant messaging, community chat rooms and the like 410.

Once a consumer member selects his/her savings and rewards offers, one embodiment of the method in accordance with the present provides for partner involvement in the e-clipping process 412. First, the SME database provides each partner with an alert or report of all e-clip transactions, including any SMA auto offers 414. Then, the SME database calculates all savings and rewards offer management fees due by each partner based on consumer member e-clips 416. Payments are reconciled via the system administrator's banking service and partner escrow funds.

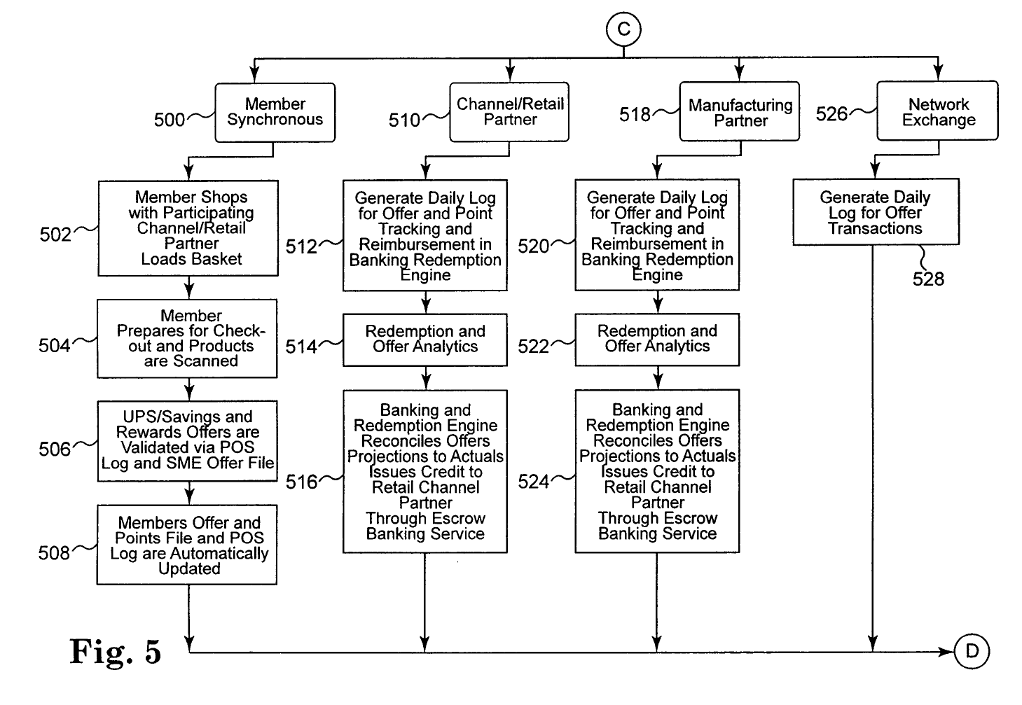

Referring now to FIG. 5, there is shown one embodiment of a method for processing savings and rewards offer redemptions at the POS. While the embodiment shown in FIG. 5 depicts simultaneous processing for members, channel partners or other retailers, manufacturer partners, and the proprietary network exchange, those skilled in the art can appreciate that processing for each of these entities can also be conducted separately and in any order.

Referring again to FIG. 5, there is shown one embodiment of processing consumer members' savings and rewards offers 500. First, a consumer member loads his/her shopping basket with products from pre-selected product savings and rewards offers from manufacturers or channel partners as well as non-partner products at participating channel/retail partner location(s) 502. Second, the basket items are scanned by the POS cashier or by the consumer member at self-service kiosk and UPCs are captured in the POS transaction log, t-log 504. Third, the cashier or consumer member totals the transaction and requests or supplies a payment vehicle and/or a consumer member identification 506. Step 506 also includes the POS system recognizing the consumer member's unique identifier and sending a message to the SME database via the proprietary network exchange in order to retrieve the savings and rewards offers on file for that consumer member 508. Step 506 also includes the SME database matching each savings and rewards offer against scanned UPCs and automatically updating the consumer member's file with savings and rewards offers redeemed and savings and points earned. Step 506 also includes the SME database transmitting a message to the POS system to complete the transaction and print all savings and rewards information on a register receipt generated at the POS. Alternately, the savings and rewards information can be provided in an on-line receipt that can be saved to the consumer member's personal page, individual computer processor or emailed or otherwise transmitted to an agent of consumer member's choosing.

Finally, the consumer member's offers and points file and the POS system are automatically updated with any new savings and rewards offers 508. In step 508, the result of the transaction is returned to the SME database and the consumer member's file is automatically updated. The SME also scores the transaction for points earned based on the manufacturer partner or other retailer's defined savings and rewards offer and credits the consumer member's point bank account on their personal page. The SME database updates the rules and inference data store with the results of the consumer member's latest transaction data and loads new, individualized savings and rewards offers, or SMA offers to the consumer member's personal page or to a registered wireless device via SMS/MMS.

Referring again to FIG. 5, there is shown one embodiment of a method for processing information associated with savings and rewards offers sponsored by channel partners and/or other retailers 510. First, the SME database calculates all fees payable to the channel partner or other retailer 512. These fees consist of offer redemption fees and register tape transaction fees.

Next, all savings and rewards offer activity is monitored and maintained in the SME database for periodic reporting to channel partners or other retailers 514. In one embodiment, partner reports are accessed via a secured Internet site. In another embodiment, partner reports are accessed by downloading them from a secured site, requesting they are emailed, faxed, sent via postal mail, or any such communication method. However, partners are not permitted to access and/or view any other partner's data. Aggregate data that includes all system activity can be reported without individual partner identification and available for review by all partners. Finally, once the fees for a channel partner or other retailer are calculated, the channel partner or other retailer is issued the appropriate credit through the system administrator's banking services partner escrow fund accounts 516.

Referring still to FIG. 5, there is shown one embodiment of a method for processing information associated with savings and rewards offers sponsored by manufacturer partners 518. First, the SME database calculates all fees payable by the manufacturer partner 520. These fees consist of item management fees, transaction fees, and offer redemption fees. Transaction fee costs are split among all partners on the register receipt per the business rules managing the banking functions. Next, all savings and rewards offer activity is monitored and maintained in the SME database for periodic reporting to the manufacturer partner 522. In one embodiment, partner reports are accessed via a secured Internet site. In another embodiment, partner reports are accessed by downloading them from a secured site, requesting they are emailed, faxed, sent via postal mail, or any such communication method. However, partners are not permitted to access and/or view any other partner's data. Aggregate data that includes all system activity can be reported without individual partner identification and available for review by all partners. Finally, the manufacturer partner's escrow and accrual funds are debited for the total amount due to the system administrator and the system administrator's operating fund is credited 524.

Referring again to FIG. 5, there is shown one embodiment for processing information related to the proprietary network exchange 526 in accordance with the present invention. The SME database calculates the transaction fees payable to the proprietary network exchange based on the number of single transaction receipts processed through the POS system 528. The system administrator's operating fund is debited. While FIG. 5 shows the transaction fees payable to the proprietary network exchange being calculated on a daily basis, those skilled in the art can appreciate that various terms can be used to define the fee calculating window, such as dollar limit, weekly accrual, monthly accrual, etc.

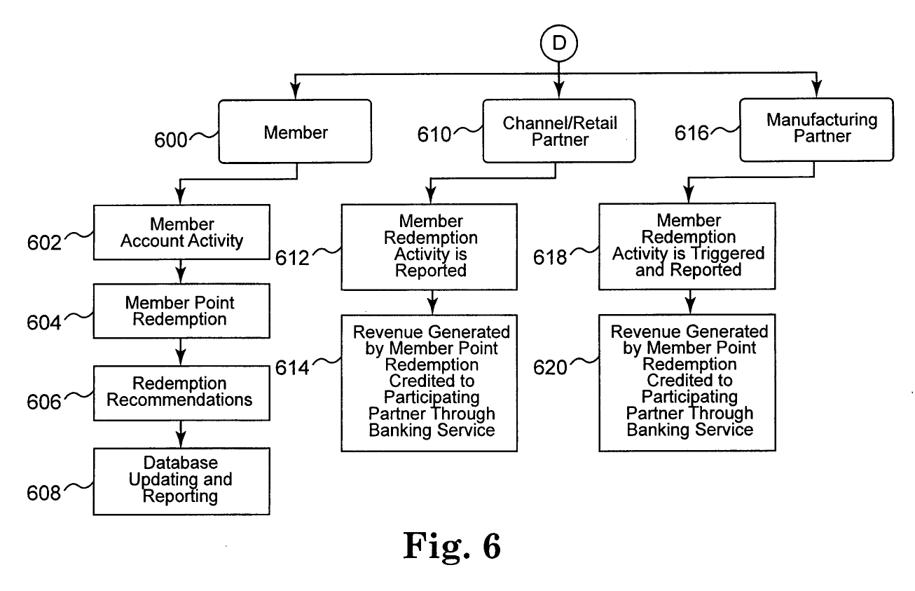

Referring now to FIG. 6, there is shown one embodiment of a method for point scoring and redemption in accordance with the present invention. While the embodiment shown in FIG. 6 depicts simultaneous processing for members, channel partners or other retailers and manufacturer partners, those skilled in the art can appreciate that point scoring and redemption for each of these entities can also be conducted separately and in any order. It should be noted that point scoring and redemption for manufacturer and channel partners or other retailers is tracked and monitored for the purpose of managing each partner's point accrual fund.

Referring again to FIG. 6, there is shown one embodiment of point scoring and redemption for consumer members 600. First, the SME database maintains a detailed history of all member account activity, including savings and points earned 602. Points can be earned in several ways, including but not limited to becoming a member; through partner offers; responding to e-surveys; performing specific shopping behavior, etc. Consumer members can earn savings and rewards from a network of participating manufacturer and channel/retail partners using their single identifier. All data are reported on the consumer member's personal page, which can be viewed by the consumer member at any time.

Next, consumer members may redeem points for partner awards upon attaining the required number of points for the award 604. Point levels are designed with scalable point thresholds wherein the value of the award increases accordingly. In one embodiment, awards can be viewed and selected by logging onto a secured Internet site. In another embodiment, awards can be accessed by downloading them from a secured site, requesting they are emailed, faxed, sent via postal mail, or any such communication method. When the consumer member selects an award, the SME database automatically records the selection. Awards can be redeemed at partner websites or at partner POS locations.

Next, the SME database automatically alerts the consumer member when sufficient points are available for redemption and will recommend specific awards based on point level availability as well as on specific member profile and activity 606. The alert can be in the form of an e-mail, an SMS text message, a website log-in message, or the like. The SME database will suggest and issue new savings and rewards offers that will enable the consumer member to attain the next point threshold and a higher value award. Finally, the SME database is updated with each award redeemed and the member's personal page will reflect the redemption and adjust the point balance accordingly 608.

Referring still to FIG. 6, there is shown one embodiment of a method for point scoring and redemption as related to channel partners and/or other retailers 601. First, an SME database reporting and tracking application generates periodic reports of all point earnings and redemption activity for participating channel partners or other retailers 612. Then, all revenue generated by award redemption is credited to the appropriate partner via a point accrual fund through the system administrator's banking service 614.

Referring again to FIG. 6, there is shown one embodiment of a method for point scoring and redemption as related to manufacturer partners 616. First, the SME database reporting and tracking application generates periodic reports of all point earnings and redemption activity for participating manufacturer partners 618. Then, all revenue generated by award redemption is credited to the appropriate partner via the point accrual fund through the system administrator's banking service 620.

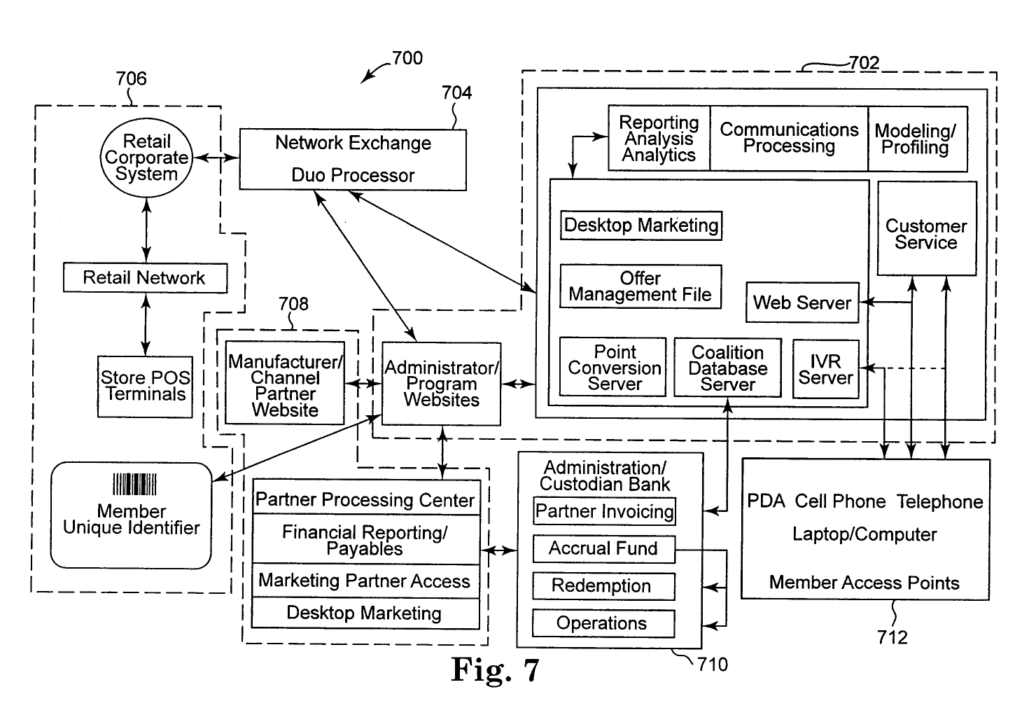

Referring now to FIG. 7, there is shown an exemplary block diagram of a network system 700 for implementing an embodiment of the invention. The network system 700 includes a proprietary database application capable of communications and data transport within and between local area and wide area networks (LAN, WAN) 702, a proprietary network exchange administrator 704 for the purpose of interfacing with partner POS hardware and validating offer UPC and transactional data, POS technology hardware 706, manufacturer and/or channel partner or other retailer network 708 capable of communications between system administrator for the purpose of transmitting and/or receiving digital content, a system administrator banking center 710 and a member access point 712. The member access point 712 includes digital wireless technology and equipment, including but not limited to cell phones, telephones, personal computers, handsets, PDA's, and the like.

The proprietary database configuration 702 may include a server and/or processor, a storage device, a network adapter or interface device, an input device, and an output device, all communicatively coupled via bus. The database server/processor may represent a central processing unit of any type of known in the art. The processor typically includes a control unit that organizes data and program storage in memory and transfers data and other information between various parts of the network system 700, for example, desktop marketing tools, customer service tools including interactive voice response systems (IVR), point conversion and offer management servers, the proprietary network exchange, system administrator's bank, and the like. The processor may receive input data from the partner and/or system administrator websites, the offer management and/or point conversion server, the proprietary network exchange 704, or the system administrator's bank, read and store code and data in the storage device, and may present output data via output devices at the member access points 712, such as personal computers, PDAs, telephones, handsets, and cell phones. The processor may also transmit and receive packets of information across the network system 700 using network adapters or interface devices.

In one embodiment of the invention, data and program storage may be output to hardware/software tools (desktop marketing, IVR, Customer Service) owned by the system administrator. In another embodiment of the invention, data and program storage may be output to hardware/software tools owned by the manufacturer or channel/retail partner and residing at their physical locations. Members have access to their personal data through the system administrator's website. However in another embodiment of the invention, member specific data is available through accessing an automated IVR system or, in another embodiment, the system administrator's customer service representatives.

The network system 700 may be any suitable network capable of supporting communication to at least one server in the proprietary database configuration 702. Although one network is shown, in other embodiments any number of networks and/or combinations of networks may be present. In an embodiment, the network system 700 may support wireless communications. In another embodiment, the network system 700 may support hard-wired communications, such as a telephone line or cable. In an embodiment, the network may be the Internet and support IP (Internet Protocol). In other embodiments, the network system 700 may be a local area network (LAN) or a wide area network (WAN). In still other embodiments, the network system 700 may support any appropriate protocol or protocols.

While the proprietary database configuration 702 in FIG. 7 depicts only a single processor and a single bus, those skilled in the art can appreciate that a proprietary database configuration 702 in accordance with the present invention may have multiple processors and/or multiple buses with some or all performing different functions in different ways.

The storage devices represent one or more mechanisms for storing data. For example, the storage devices may include read only memory (ROM), random access memory (RAM), magnetic disk storage media, optical storage media, flash memory devices, and/or other machine-readable media.

While the invention has been described with reference to the specific embodiments thereof, those skilled in the art will be able to make various modifications to the described embodiments of the invention without departing from the true spirit and scope of the invention. The terms and descriptions used herein are set forth by way of illustration only and are not meant as limitations. Those skilled in the art will recognize that these and other variations are possible within the spirit and scope of the invention as defined in the following claims and their equivalents.

What is claimed is:

1. A method for a cost-effective smart shopping program embodied on a computer readable medium, comprising:
uploading participating partners' digital savings and rewards offers to a program administration website;
approving offer content by a system administrator and escrow payment of all savings and rewards offer liabilities by participating partners;
activating approved savings and rewards offers through a program interactive website;
providing members' selection of relevant savings and rewards offers through a computing means and selecting savings and rewards offers to be stored on a secure offer management file;
storing member selections and purchase history in a secure offer management database;
providing one unique identifier for redeeming digital offers from a plurality of partners at or through a point of sale system;
reporting and tracking of members' savings and rewards offer selections and redemptions; and
providing banking and accounting functions for reconciliation and reimbursement to participating partners.

2. A smart shopping computer program stored on a computer readable medium, the program comprising:
a code segment for uploading participating partners' digital savings and rewards offers to a program administration website;
a code segment for approving offer content by a system administrator and escrow payment of all savings and rewards offer liabilities by participating partners;
a code segment for activating approved savings and rewards offers through a program interactive website;
a code segment for providing members' selection of relevant savings and rewards offers through a computing means and selecting savings and rewards offers to be stored on a secure offer management file;
a code segment for storing member selections and purchase history in a secure offer management database;
a code segment for providing one unique identifier for redeeming digital offers from a plurality of partners at or through a point of sale system;
a code segment for reporting and tracking of members' savings and rewards offer selections and redemptions; and
a code segment for providing banking and accounting functions for reconciliation and reimbursement to participating partners.

3. A computerized system for a smart shopping software application comprising:
a processor; and
a storage device comprising:
a code segment for uploading participating partners' digital savings and rewards offers to a program administration website;
a code segment for approving offer content by a system administrator and escrow payment of all savings and rewards offer liabilities by participating partners;
a code segment for activating approved savings and rewards offers through a program interactive website;
a code segment for providing members' selection of relevant savings and rewards offers through a computing means and selecting savings and rewards offers to be stored on a secure offer management file;
a code segment for storing member selections and purchase history in a secure offer management database;
a code segment for providing one unique identifier for redeeming digital offers from a plurality of partners at or through a point of sale system;
a code segment for reporting and tracking of members' savings and rewards offer selections and redemptions; and
a code segment for providing banking and accounting functions for reconciliation and reimbursement to participating partners.
